(19) United States
(12) Patent Application Publication
(10) Pub. No.: US 2002/0143433 A1
(43) Pub. Date: Oct. 3, 2002

(54) System and method for providing information concerning a live event

(76) Inventor: Tibor T. Tallos, Mountville, PA (US)

Correspondence Address: Philip M. Weiss, WEISS & WEISS, 500 OLD COUNTRY ROAD, GARDEN CITY, NY, 11530, US

(21) Appl. No.: 10/101,082

(22) Filed: Mar. 19, 2002

Related U.S. Application Data
(60) Provisional application No. 60/277,142, filed on Mar. 19, 2001.

(51) Int. Cl. G06F 17/00

(52) U.S. Cl. 700/235

(57) ABSTRACT

A system and method for providing information concerning a live event, tourist attraction, etc. to a material object via a kiosk, the Internet, a personal computer or other electronic system.

### FIELD OF THE INVENTION

The present invention relates to a system and method for providing information concerning a live event, tourist attraction, etc. to a material object via a kiosk, the Internet, a personal computer, or other electronic system.

### BACKGROUND OF THE INVENTION

Kiosks have been used for providing tickets and greeting cards. These prior art uses relate to providing textual material which can be inserted at designated locations on a card. These cards have prestored graphic design elements.

U.S. Pat. No. 5,615,123 relates to a system for creating and producing custom card products. The patent relates to a method of and apparatus for creating and producing printed card products, such as greeting cards for various applications, whereby a customer can select a card product for a desired application and customize or personalize certain portions of the selected card product. A terminal area or kiosk is provided at which the customer selects from a monitor screen display one of a number of different general applications for which they want to obtain a card product. Upon entry of the selection, one or more prestored groups of card product design formats pertaining to the selected general application are determined, and further inquiries are made to elicit information relating to a specific use or application for the desired card product. Once this information is entered, certain ones of the determined card product design formats are identified as pertinent and displayed to the customer who can choose a card product format to customize. The customized card product is then created.

U.S. Pat. No. 5,687,087 relates to a card printing and dispensing system located at the venue of an ongoing or recently completed entertainment event and including a video display monitor, a customer interface, a printer, and a computer control. A customer interested in purchasing a card selects using the customer interface from a variety of options displayed on the video monitor a desired card unique to the particular ongoing or recently completed entertainment event for printing and dispensing by the system. The system is particularly suited to printing and dispensing unique baseball cards which would include information corresponding to an individual game or series of games and available only at the venue where the individual game or series of games were actually played.

### SUMMARY OF THE INVENTION

The present invention comprises a system and method for dispensing information material which was presented at a live event.

The present invention relates to a system for dispensing information material which was presented at a live event. The information can be produced during the event, immediately after the event or at a later time. The system comprises a recording apparatus for recording a live event. The recording apparatus is connected to a computer which stores information regarding the event. The computer is connected to a dispensing apparatus which dispenses the information onto a material object. The dispensing apparatus has a customer interface where a user selects the information to be downloaded onto the material object. The system further comprises a printing apparatus for download the information from the computer to a material object. The printing apparatus may download a picture onto a card, download music onto a CD, or download video onto a cassette. Material objects can be stored in the dispensing apparatus or placed in the dispensing apparatus for downloading the information.

It is an object of the present invention for the material objects to include, cards, tapes, CDs, floppy disks, videos and sheets of paper. It is an object of the present invention for the material objects to have preprinted information on it concerning the live event. It is an object of the present invention for the information to be an audio of an event or portions of an event. It is an object of the present invention for the information to be a video of an event or portions of an event.

It is a further object of the present invention for the dispensing apparatus to comprise Kiosks, Internet, a personal computer or other electronic devices. It is an object of the present invention for the dispensing apparatus to be located at the site of an event, such as a sporting event, concert, or at a tourist attraction. It is an object of the present invention for the dispensing apparatus is located at a user's home, or office.

It is an object of the present invention for the kiosk to be stocked with an inventory of material objects, i.e., cards or paper for printing, or stocked with tapes, CDs, or floppy disks for audio or videos.

It is an object of the present invention for the customer interface to be a keypad, touch screen or microphone. It is an object of the present invention for the recording apparatus to be a video camera, digital still camera, or sound recording device.

It is an object of the present invention for the system to further comprise a system for accepting payment. It is an object of the present invention for the system for accepting payment to comprise; a slot for receiving monetary denominations, a device for sweeping a credit card or a system for verifying of credit or debit card by a remote database having verification information.

It is an object of the present invention for the computer to have information prestored on it relating to the persons performing at the live event.

The present invention relates to a method for dispensing information material which was presented at a live event comprising; inputting information into a dispensing apparatus regarding downloading information to a material object. The information is received by a computer that interacts with a customer through a video monitor or via a wireless device. The user searches for a particular action that happened during an event or the system provides the user with a choice of actions to have printed on the material object. Based on the user's choice, the system provides to the user a sample of written information about an action, displays a picture of what will be printed on the material object or provides a partial recording to a user from the system. The user then confirms the selection or chooses a further selection. Once a selection is chosen, the information is downloaded onto the material object and delivered to the user.

It is an object of the present invention for the material objects to include, cards for printing, tapes, CDs, floppy disks, videos and sheets of paper. It is an object of the present invention to provide information regarding a live event on cards printed and dispensed at a kiosk which is operable by a user. It is an object of the present invention to provide information in the form of an audio of an event or portions of an event. It is an object of the present invention to provide information in the form of a video of an event or portions of an event.

It is an object of the present invention for the dispensing apparatus to comprise a kiosk, or personal computer, etc. It is an object of the present invention for the dispensing apparatus to be located at the site of an event, such as a sporting event, concert, or at a tourist attraction. It is an object of the present invention for the dispensing apparatus to be located at a user's home, or office.

It is an object of the present invention to provide a dispensing apparatus at other locations other than the event which can dispense video, audio or other information from a live event onto a material object. It is an object of the present invention to provide a kiosk which is stocked with an inventory of material objects, i.e., cards or paper for printing, or stocked with tapes, CDs, or floppy disks for audio or videos.

It is an object of the present invention for the merchandise to be controlled through a customer interface, such as a keypad or touch screen, and information regarding the transaction is displayed to the customer on a video monitor. It is an object of the present invention to allow a user to request the information via voice interaction. The customer inputs what they are requesting and the request is received by a computer that interacts with the customer through the video monitor or via a wireless device.

The customer can either search for a particular action that happened during the event or the dispensing apparatus through a monitor can provide a user with a choice of actions to have printed on the material object. In one embodiment, the system can provide written information about an action or show a picture of what will be printed on the material object. Once a selection is made by the user, the system sends the information to the material object and dispenses the material object to the user.

It is an object of the present invention to provide sports cards. It is an object of the present invention to provide concert cards. It is an object of the present invention to provide tourist site cards.

### DETAILED DESCRIPTION OF THE INVENTION

In one embodiment, a user attends an event. At the event is located a kiosk which has stored in it a number of blank material objects, or a user can provide the blank material objects to the kiosk. In one embodiment, the material objects are blank or preprinted cards. In a second embodiment, the material objects are tapes or CDs, etc. for burning an audio. In a further embodiment, the material objects are tapes or other devices for playing a video. The kiosk is connected to a device which is taping the event live.

A user goes up to the kiosk and chooses the type of action which they want printed onto the material object. The kiosk can either give the user a choice of actions to choose from or the user can provide information to the kiosk regarding which action the user wishes to purchase. For instance, if the user is attending a concert, the kiosk monitor can offer different photos of events during the concert. These photos can be shown to the user as actual photos which will be printed on a card or can be written information describing what will appear on the card. In a preferred embodiment, the cards can also have printed information displayed on the front or back of the card. This information can include the date of the event or other information regarding the event. This information can be prestored on the cards or be printed when the action is chosen to be printed on the card. In a further embodiment, the user can search for or describe what action they would like printed on the card. For example since the kiosk can be connected to a system that is taping the event live, the user may know where in the concert an action occurred and search for that action at the kiosk. When a user finds the action they want to print, they can instruct the kiosk to print the action onto the material object.

In a further embodiment, a user at an event can approach a kiosk and request an audio tape of an event or portions of an event. For example, a user can attend a concert, and either during the concert or after the concert approach a kiosk and request certain songs from the concert be downloaded or burned onto a CD, recorded onto a tape or downloaded to a Rio, Palm Pilot, Lap Top or Real Player. In an embodiment, the video monitor of the kiosk can provide the names of the songs, which the user can choose. In a further embodiment, the user can search for the songs that they request be downloaded.

In a further embodiment, a user can approach a kiosk and select video of the event that they were attending. The video can then be downloaded onto a material object. The user can, for example, select from actions which are identified on the monitor of the screen. For example, if a user attends a sporting event, the list of actions can include great plays that occurred during the game or bloopers that occurred during the game. The user can choose specifically a player and have a video regarding that player downloaded onto a material object. The user can also download a still picture of that player during that play or from a pre-recorded gallery of portraits/photos.

In a further embodiment, a user can go to a dispensing, apparatus, i.e., kiosk, or personal computer, which is connected to a system which is gathering information, i.e., video and/or audio, of a live event. The dispensing apparatus does not have to be located at the event, but can be located anywhere including a mall, office building, or a home.

1. A system for dispensing information material which was presented at a live event comprising;
a recording apparatus for recording a live event;
said recording apparatus connected to a computer which stores information regarding said event;
said computer connected to a dispensing apparatus which dispenses said information;
said dispensing apparatus having a customer interface;
a printing apparatus for downloading said information from said computer to a material object;
material objects stored in said dispensing apparatus or placed in said dispensing apparatus for downloading said information.

2. The system of claim 1 wherein said material objects include, cards, tapes, CDs, floppy disks, videos and sheets of paper.

3. The system of claim 1 wherein said material objects have preprinted information on it concerning said live event.

4. The system of claim 1 wherein said information is an audio of an event or portions of an event.

5. The system of claim 1 wherein said information is a video of an event or portions of an event.

6. The system of claim 1 wherein said dispensing apparatus comprises;
Kiosks, internet, personal computer, or other electronic devices.

7. The system of claim 1 wherein said dispensing apparatus is located at site of an event, such as a sporting event, concert, or at a tourist attraction.

8. The system of claim 1 wherein said dispensing apparatus is located at a user's home, or office.

9. The system of claim 6 wherein said kiosk is stocked with an inventory of material objects, i.e., cards or paper for printing, or stocked with tapes, CDs, or floppy disks for audio or videos.

10. The system of claim 1 wherein said customer interface is a keypad, touch screen or microphone.

11. The system of claim 1 wherein said recording apparatus is a video camera, digital still camera, or sound recording device.

12. The system of claim 1 further comprising;
a system for accepting payment.

13. The system of claim 12 wherein said system for accepting payment comprises;
a slot for receiving monetary denominations, a device for sweeping a credit card or a system for verifying of credit or debit card by a remote database having verification information.

14. The system of claim 1 wherein said computer has information prestored on it relating to the persons performing at said live event.

15. A method for dispensing information material which was presented at a live event comprising;
inputting information into a dispensing apparatus regarding downloading information to a material object;
receiving a request by a computer that interacts with a customer through a video monitor or via a wireless device;
searching for a particular action that happened during said event or providing a user with a choice of actions to have printed on the material object;
providing a sample of written information about an action, displaying a picture of what will be printed on said material object or providing a partial recording to a user from said system;
said user confirming said selection or choosing a further selection;
sending said information to said material object;
dispensing said material object to said user.
